(19) United States
(12) Patent Application Publication
(10) Pub. No.: US 2026/0159056 A1
(43) Pub. Date: Jun. 11, 2026

(54) METHOD FOR ELECTRONIC AIR GAP CONTROL OF A MOTOR VEHICLE WHEEL BRAKE AND ELECTRONIC MOTOR VEHICLE BRAKING SYSTEM FOR SAME

(71) Applicant: Continental Automotive Technologies GmbH, Hannover (DE)

(72) Inventors: Jürgen Balz, Huenstetten Oberlibbach (DE); Jens Hoffmann, Darmstadt (DE); Christian Vey, Petersberg (DE); Martin Gädke, Hofheim (DE); Sébastien Pla, Darmstadt (DE)

(73) Assignee: Continental Automotive Technologies GmbH, Hannover (DE)

(21) Appl. No.: 18/706,609

(22) PCT Filed: Oct. 27, 2022
(86) PCT No.: PCT/DE2022/200248

§ 371 Date: May 1, 2024

(30) Foreign Application Priority Data
Nov. 1, 2021 (DE) 10 2021 212 288.4
Mar. 16, 2022 (DE) 10 2022 202 615.2

(51) Int. Cl. B60T 13/74; B60T 17/22; F16D 65/54

(52) U.S. Cl. CPC B60T 13/741; B60T 17/22; F16D 65/546; B60T 2201/12

(57) ABSTRACT

A method for electronic air gap control of an electrical motor vehicle brake system comprises electrical wheel brakes, wherein a resting position is adopted and maintained by supplying electric energy. Mechanical elements for adjusting the resting position can thus be dispensed with. Furthermore, an electrical motor vehicle brake system comprising electrical wheel brakes for carrying out such an electronic air gap control method is described.

### CROSS-REFERENCE TO RELATED APPLICATION

This U.S. patent application claims the benefit of PCT patent application No. PCT/DE2022/200248, filed Oct. 27, 2022, which claims the benefit of German patent application No. 10 2021 212 288.4, filed Nov. 1, 2021, both of which are hereby incorporated by reference.

### TECHNICAL FIELD

A method for electronically controlling a brake air gap such as, for an electrical wheel brake of a motor vehicle is described.

### BACKGROUND

Electrical wheel brakes are typically used in motor vehicles in order to decelerate the latter. Drum brakes, in particular, and also disk brakes are widely used. Brake shoes are used in particular in order to generate a braking effect. Spring means, which may be pre-loaded, and can always act on the brake shoes in order to withdraw the brake shoes from frictional engagement are sometimes provided. For example, elastically pre-loaded tension springs can be used in hydraulically activated drum brakes in order to reset the brake shoes after the pressure build-up, as a result of which an air gap between the brake shoes and the drum is created and residual momentums are avoided. For the avoidance of excessively tight contraction, thus an excessively large air gap, a mechanical adjuster can be used in simplex drum brakes, for example, said adjuster counteracting this. Often, this adjuster simultaneously causes an automatic readjustment process in the event of wear on the pads, because a spindle/nut mechanism, which in most instances is activated by a stepping mechanism, expands as a function of the expansion travel. Adjusters of this type are typically sensitive to tolerances and may be subject to disturbance variables. For example, if an air gap is set to be excessively small, residual momentums can be created. These can lead to the wheel brake generating a braking momentum also during travel, this leading to unnecessary wear and unnecessary consumption of energy, for example. Moreover, in the known systems the brake shoes must always have a special restoring spring mechanism, or at least one hardware component with a restoring spring effect, which acts indirectly or directly on the brake shoes, this always increasing the complexity in terms of construction, or the structural complexity, respectively. The systems or methods known to date do not meet the increased demands set for electrical wheel brake systems of a modern design, which include electric wheel brake actuators.

### BRIEF SUMMARY

It is therefore an object to provide a method for electronic air gap control, which is of an alternative or improved embodiment in comparison to the prior art. It is furthermore an object to provide an electronic motor vehicle brake system having electrical wheel brakes for the purpose of carrying out the electronic method.

A method for electronic air gap control of an electrical wheel brake for a motor vehicle is provided. The electrical wheel brake has for example at least one brake shoe which is electronically activatable by an electric actuator by means of at least one electronic control unit (ECU), and is provided to be releasable. The electronic air gap control method, or air gap maintaining method, respectively, herein primarily comprises the following steps: electrically adopting a (brake) resting position in which a specified air gap is adjusted; and supplying electric energy to the actuator (resting energization) in such a way that the adopted resting position is maintained.

Accordingly, in the method the resting position of a vehicle wheel brake is for the first time not defined conventionally, rigidly, mechanically, by way of example by the so-called adjuster device in a mandatory combination with elastically pre-loaded restoring springs based on the hydraulic drum brakes according to a known prior art, but is for the first time defined electrically in a customized manner, i.e. defined individually in a customized manner and electrically controlled in that electric energy is individually applied in a defined manner. Consequently, special control for maintaining an individualized, customized resting position of a brake actuation mechanism in an electrical passenger motor vehicle wheel brake to be offered for the first time, without simultaneously triggering an unmanageably increased complexity in terms of devices (sensors) on this passenger motor vehicle component which is stressed to the maximum and is relevant in terms of safety.

In a specification, the electric energy applied is for example an electric current which is determined in a wheel-specific and microprocessor-assisted manner and is applied in a defined individual manner to the respective electric brake actuator. This is the so-called holding current which is transmitted by the control unit to the electric actuator as a controlled direct current, all this being present in a DC onboard power system of a motor vehicle. The effect of this energy, which is supplied in a defined controlled manner, and for example of the defined holding current, herein is directed and rated in such a way that, for example, a restoring means effect of at least one elastic restoring spring, restoring means, roll-back rings, knock-backs, or the like, which could impinge directly or indirectly a brake shoe in a restoring direction (“reverse direction”), is reduced by at least a minor specific degree. An electric energy which is applied individually to an electric wheel brake actuator for adjusting the resting position of the latter in this way consequently causes at least one, optionally even only a relatively minor, actuator actuation procedure which is suitable and specified to compensate, or gradually alleviate, effects directed counter to one another, such as spring mechanism-based effects of restoring means in terms of the respective brake shoe(s). That is to say to gradually compensate this restoring means effect in such a way that no rear end position of the brake shoes, or brake pads, respectively, arbitrarily defined in a purely mechanical manner prevails. Rather a resting position of the respective wheel brake that has been adjusted in a customized manner and applied in a defined manner in terms of electric energy. In the driving mode of the vehicle, this resting position electrically adjusted includes the air gap, or an air gap range L, which has been actuated in a customized and wheel brake-specific manner, this taking into account the prevailing or desired operating conditions and/or parameters. By adopting the resting position of the friction brake in such a controlled manner, frictional wear as a result of shrinking consumable parts is automatically compensated for, and an excessive restoring action is simultaneously prevented in an economical manner. Wear limits herein can be determined and readjusted in a wheel-specific manner by way of a kiss point detection KP of the respective wheel brake and/or by reconciliation by means of actuator current detection.

For the purpose of reducing stress on an electric onboard power system of a vehicle it can be specified that the described wheel brake resting position with an air gap setting adjusted in a defined manner, which is defined in terms of energy and is electrically actively maintained, applies only to an active driving mode of the vehicle (vehicle driving mode identified—such as, for example, ignition on+parking brake released).

Issues described at the outset, for example in terms of tolerances and dependency on operating parameters, can be avoided by means of wheel-specific electric control. The electric energy can be used to maintain the air gap for a temporal period in which for example no braking action takes place. Accordingly, the electric energy can be permanently supplied. The electric energy can also be supplied depending on the situation and/or in a customized manner. In other words, the electric energy is supplied typically as long as the air gap is to be maintained, thus typically as long as no braking force is to be built up. Interruptions which are related to control technology, for example, are not in conflict with the supply of electric energy, or do not terminate the latter, respectively.

For example, the electric energy can be supplied in the form of a constant resting current, which can take place in the case of a simple electric motor, for example. However, in the case of electronically commutated motors, the electric energy can also for example be supplied in a considerably more complex form, wherein phases are actuated in a targeted manner, for example. In the process, the phases can be constantly actuated, or else variably actuated while maintaining the air gap.

An air gap is understood to mean for example a spacing of a brake shoe from a brake rotor, or from a brake disk, or a similar element. The air gap should be large enough that a residual momentum is avoided, i.e. that no braking momentum is built up when there is no braking force requirement. On the other hand, said air gap should also be small enough that a rapid activation of the wheel brake can take place. The resting position is typically that position along a displacement path of the actuator at which the air gap range is adjusted in such a way that the brake shoe(s) has the desired spacing from the brake rotor.

According to one embodiment, the wheel brake is a drum brake. According to a further embodiment, the wheel brake is a disk brake. The method described herein has proven] successful for wheel brakes of this type. In principle however, said method can be used for all wheel brakes in which one or a plurality of brake shoes are activated by an electric actuator.

The resting position can be continuously updated during operation of the wheel brake. As a result, changes in the wheel brake which can arise over time can be taken into account. For example, wear on the wheel brake, which can be created by abrasion on brake pads, can be taken into account. The update can be performed, for example, by recording force/displacement characteristic lines.

In one embodiment, the wheel brake has a rear end stop for the brake shoe. It is possible in principle that a rear end stop of this type can be electrically adopted in an actuator-assisted manner, for example in order to carry out the replacement of a brake shoe. It is possible for there to be one or a plurality of restoring means which can be present as elastically pre-loaded spring means and which can impinge the brake shoe. In the case of a drum wheel brake, a restoring spring means can be clamped between two brake shoes, as an elastically pre-loaded tension spring, for example. This serves to ensure that each brake shoe is fundamentally de-energized and permanently elastically pre-loaded in the direction of the non-activated position (rear end stop). As a result, brake shoes have the general tendency to make their way to this released non-activated position (rear end stop), so that no braking momentum is generated in case a wheel brake is not intended to be activated, or else in the event of a malfunction.

According to one embodiment however, the wheel brake does not have any mechanical restoring (spring) means/air gap adjustment means at all. The desired air gap range/the desired air gap is thus adjusted and maintained exclusively by the process described herein, by means of supplying electric energy as mentioned. For example, the adjuster described earlier can be dispensed with. A mechanical air gap adjustment means could be designed in such a way, for example, that the movement of the brake shoe, or of the brake shoes, away from the drum or the disk is delimited in an adjustable manner. Such a mechanical air gap adjustment means is not mandatory when using the method described herein but may nevertheless be present.

For example, the electric energy supplied can have an output of at most 1 W. Values of this type have proven successful for typical applications. They are typically easy to take into account, because they stress the onboard power system of a motor vehicle and the energy footprint of the latter only to a minor degree, and are thus acceptable for adjusting the air gap in the manner described herein. In principle however, higher outputs can also be used.

The electric energy supplied can for example be controlled to maintain the resting position. In this way, monitoring of the resting position can be implemented, for example, wherein the electric energy is increased or decreased should any deflection from the desired resting position occur. This can for example also be performed in more complex motor controls such as, for example, a phase control of an electronically commutated motor.

For example, the actuator can be connected to the brake shoes in such a way that said actuator can actively retract the brake shoes. This can also be considered to be an independent feature. For example, restoring means or other mechanical restoring means can be dispensed with in this case. In other words, in this case the actuator can actively activate the brake shoes in both directions in such a way that the latter can also be removed from a brake rotor or a brake disk by means of the actuator. For this purpose, the actuator can for example be fixedly connected to the brake shoes, for example by way of joints.

The resting position can be tracked as a function of one or a plurality of parameters. Such parameters can be, for example, operating parameters such as temperature or aging. The resting position may be tracked based on one measured force/displacement characteristic line, or a plurality of measured force/displacement characteristic lines. Force/displacement characteristic lines of this type can be recorded, for example, while the motor vehicle is stationary, and/or can be recorded during initialization. For example, the resting position can be newly determined at the beginning of each ignition run. Such an ignition run can be started, for example, when the motor vehicle is put back into operation after parking, i.e. when the driver activates the motor vehicle in order to drive away in it, for example.

In one embodiment, in cooperation with and/or for all conceivable design embodiments or variations of the control method and/or vehicle brake system, there is a mode-dependent air gap adaptation which is suitable, in that a braking behavior is able to be designed to be adaptable in a reproducible and mode-dependent manner by means of adapting the air gap control. The embodiments enable a definition of mutually dissimilarly sized, adaptable air gap positionings as a function of mode, which enables an electronically machine-assisted, i.e. automatic and/or vehicle driver-assisted, pre-selectable air gap adaptation and air gap mode definition. In this context, it is conceivable by way of example that the electronic control unit, or a vehicle driver, selects a sport mode for the sizing of the air gap, and wherein this sport mode by way of example cooperates with an air gap width which is defined to be very tight, so that a sportily accelerated vehicle braking behavior, thus a vehicle braking behavior which has a reduced empty travel and is accelerated in a safety-accentuated manner can be guaranteed while maintaining a tight air gap size, which by way of example can at all times guarantee shortest stopping distances. In contrast to a mode of this type, it is made possible, by way of example, to provide a “terrain” and/or “green mode” having in each case an air gap width which is tuned to be gradually increased to a dissimilar degree, so that dragging of the brakes, and a gradual residual braking momentum, are reliably precluded even in the event of maximum brake contamination, so that a correspondingly modified braking behavior can be realized in an electronically reproducible manner as desired or if required. The differentiation of the different air gap widths which are defined in a customized manner is in principle able to be defined in a freely programmable manner by software parameters on the lower vehicle level, and variable by software with manageable complexity, but safeguarded against unauthorized abuse. An air gap mode selection can have an effect on all electrical wheel brakes of a brake system, or it is alternatively able to be defined that a selective effect on only very specific wheel brakes is intended. By way of example, a selective effect relates exclusively to wheel brakes of a brake circuit and/or a vehicle axle that are combined in pairs, specifically by way of example selectively only to the wheel brakes of a front axle. By way of example, an adaptively adapted air gap width for a so-called green mode (on-road operation of the vehicle) can be at least approximately double the size of that of a so-called sport mode. In contrast, a so-called terrain mode (terrain operation, poor surface operation) by way of example could be realizable with triple the air gap size for reasons of contamination.

The described adaptively designed electronic air gap control method and the respective electrical brake system can finally include a so-called fail-safe mode for the purpose of a specially secured air gap control of the wheel brakes thereof. In this context, the pre-programmed, defined, fail-safe mode is prioritized in the case of a brake system fault that has been identified by way of example. This has the consequence, by way of example, that all systems, components and parts, such as electrical wheel brakes, that are identified as being free of faults, are addressed by a safety-accentuated air gap which at all times ensures maximum driving safety while taking into account the identified fault. For safety reasons, any driver-assisted air gap mode selection, such as for example the manual air gap mode selection, is precluded in this situation. This is because safety, i.e. the fail-safe mode, takes precedence.

For the purpose of appropriate cooperation and/or tuning and interaction of a vehicle friction brake system with a recuperative vehicle brake system, and vice versa, mutual electronic networking between electrical control apparatuses is provided, wherein this electronic networking can include a control-technology data exchange pertaining to status and the state of the different components and systems, such as for example an exchange of data pertaining to the air gap control and/or air gap mode selection. By way of example, as a result it is made possible that by way of reconciliation, conjointly with a particular air gap mode selection, proceeding from the friction brake system, a systematically matching terrain mode, sport mode and/or green mode drive/recuperation brake configuration can be mirrored in a quasi-flanking/accompanying manner in the electrical control unit ECU of a parallel powertrain/(recuperative) vehicle brake system, and/or vice versa.

The embodiments furthermore relate to an electronic brake system having at least one electronic control unit including a plurality of electrical wheel brakes for a motor vehicle. All electrical wheel brakes are configured to carry out an air gap control method in the system. With regard to the method, reference can be made to all of the embodiments and variants described herein.

For example, such a wheel brake can have a control apparatus which is configured in order to carry out a method. Said wheel brake can have, for example, an actuator and one or a plurality of brake shoes which are activatable by the electric actuator.

Furthermore, restoring means can be used, for example. Once the actuator has adopted the air gap position, the position can be adjusted, or re-adopted if required, by permanent or minor situation-dependent energizing. The latter can take place for example if frictional forces are lower than restoring forces, due to a transmission hysteresis. Minor electric outputs of, for example, at most 1 W, or else less, are justifiable over time, and do not lead to any noticeable increase in temperature in the actuator. Should the air gap increase after the ignition is turned off, it is the task of an algorithm to readjust the air gap, for example after the vehicle has been started up again. Should the air gap become inadmissibly small after the drums have cooled down, a temperature model as well as an expansion force sensor system can ensure a correction.

According to one embodiment, restoring means can also be dispensed with, and the brake shoes can be coupled for example to an expansion mechanism. Because the motor can actively retract the brake shoes when releasing, no forces which change the air gap are present after the adjustment of the air gap, as opposed to a hydraulic activation. For example, when the stored spring force is not sufficient due to bracing of the wheel brake, springs with a reduced spring force can optionally be used, which in the case of a fault, for example in the event of a power failure, minimize residual momentums but cannot completely drive back the transmission, in particular owing to the transmission friction.

Mechanical readjustment devices may be dispensed with. The adjustment of the air gap may be performed by means of the method described herein. Incorrect readjustments due to thermal disturbance variables or high activation forces can be avoided. The air gap may be adjusted in a situation-dependent manner (mode selection); for example, said air gap can be automatically adjusted to be small in the case of a possible identified risk of collision, and said air gap can for example be adjusted to be very large for a rapid reduction of the residual momentums with subsequent adjustment to the ideal position. Consequently, residual braking momentums may be reduced in the shortest possible time.

The present embodiments systematically and, in the broadest sense, are predestined to deliver a ecological partial contribution toward the required reduction of CO₂/reduction of climatic effects related to individual transportation/i.e. contribution toward reducing greenhouse gases with a justifiable complexity by means of functional systems+wheel brake improvements, without intervening in an unjustifiably cost-intensive manner in a vehicle architecture defined by evolution. In the process, the embodiments can readily cooperate with all energy sources. This relates specifically to the given defined energy sources such as internal combustion engines (liquid, gaseous), HEV, EV (rechargeable battery technology) and even also future energy sources such as, for example, hydrogen-based fuel cell configurations.

The method described herein can be used for, for example, electrically activated drum brakes or electrically activated disk brakes. In particular, all construction forms can be used, for example simplex, duo-servo, etc. The method can be used for service brakes as well as for parking brakes as well as for combined service and parking brakes.

Typical adjusters which are used in embodiments according to the prior art can typically additionally also compensate for the wear on the pads in a travel-controlled manner, and in some instances prevent unintentional readjustment as a result of the expansion of the hot drum. These two types of control typically represent a compromise between many different system states, parts tolerances, etc., which are typically conceived in such a way that the worst case scenario, for example an excessive residual momentum or jamming, is prevented. As a result, the ideal air gap is typically never adjusted by such mechanical readjustment devices.

The potential offered by intelligent actuation can be exploited by means of the embodiment described herein. The use of mechanical regulator structures and of unnecessary components can be avoided.

For example, the air gap position can be adopted, and the position can be maintained in a permanent controlled manner by means of permanent, for example very minor, energizing of the actuator for compensating a restoring means force, or for a required correction by virtue of specific disturbance variables such as, for example, vibration excitations, or a new ignition run, respectively. Coupling of the expansion device to the brake shoes can also take place, as a result of which the shoes can be fixedly positioned in a rigid manner in the activation direction as well as in the releasing direction. The restoring means herein may be dispensed with or at least reduced.

### BRIEF DESCRIPTION OF THE DRAWINGS

In the figures, in a schematic and substantially exemplary, simplified manner:

FIG. 1 shows an electrical wheel brake in a first state;

FIG. 2 shows the wheel brake as in FIG. 1, in a second state;

FIG. 3 shows the wheel brake in a third state;

FIG. 4 shows parts of a force/displacement characteristic line for different states of brake wear;

FIG. 5 shows the actuating force characteristic line, obtained by sensor by the responsible ESC-ECU, including the actuator current characteristic line which is obtained synchronously therewith by means of actuator current sensing, in each case plotted over time; and

FIG. 6 shows a simplified embodiment of an electronic motor vehicle brake system having an ESC-ECU networked with an electrically recuperating powertrain having a powertrain ECU (M-ECU).

### DETAILED DESCRIPTION

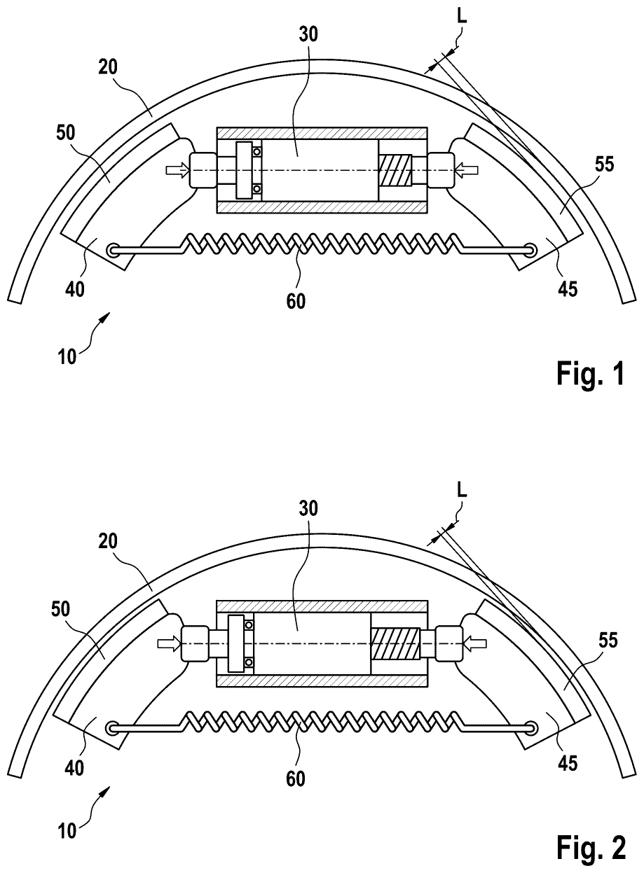

FIG. 1 shows a wheel brake 10 according to an exemplary embodiment, in a first state. The wheel brake 10 is presently embodied as a drum brake. For this purpose, said wheel brake 10 has a brake rotor 20 which in a manner not illustrated is connected to a shaft to be braked.

The wheel brake 10 has an electric actuator 30 for activation. Said actuator 30 is presently embodied as an expansion unit. The wheel brake 10 furthermore has a first brake shoe 40 and a second brake shoe 45. These are connected to the actuator 30 so that they can be compressed by the actuator 30. A first brake pad 50 is attached to the first brake shoe 40. A second brake pad 55 is likewise attached to the second brake shoe 45. The wheel brake 10 furthermore has a restoring means 60 which connects the two brake shoes 40, 45 to one another. As a result, the brake shoes 40, 45, when not activated, are pre-loaded in such a way that the brake pads 50, 55 do not touch the brake rotor 20. It is thus prevented that a braking momentum is built up should no activation be intended to take place, or should a system fault be present.

FIG. 1 shows a state in which the actuator 30 is not actuated, i.e. in which the brake shoes 40, 45 are in a maximum retracted position. An air gap L, which defines a spacing between the brake pads 50, 55 and the rotor 20, is adjusted in the process. The air gap L thus ensures that no braking momentum is built up.

FIG. 2 shows another state of the wheel brake 10. The air gap range/the air gap L here is embodied to be smaller. For this purpose, electric energy is applied to the actuator 30 in such a way that the latter partially compensates the effect of the restoring means 60. The brake pads 50, 55 herein do not yet bear on the brake rotor 20, but when activated can be brought to bear faster than would be possible when proceeding from the state illustrated in FIG. 1.

Applying a minor electric energy does indeed lead to a consumption of current, but the latter is so minor that it is relevant neither in terms of the stress on the onboard power system nor in terms of the heating of the actuator nor in terms of the energy footprint of the motor vehicle. However, the mechanical adjusters or similar mechanical devices for adjusting the air gap L may be dispensed with. Moreover, the air gap L can be precisely adjusted using the procedure described herein.

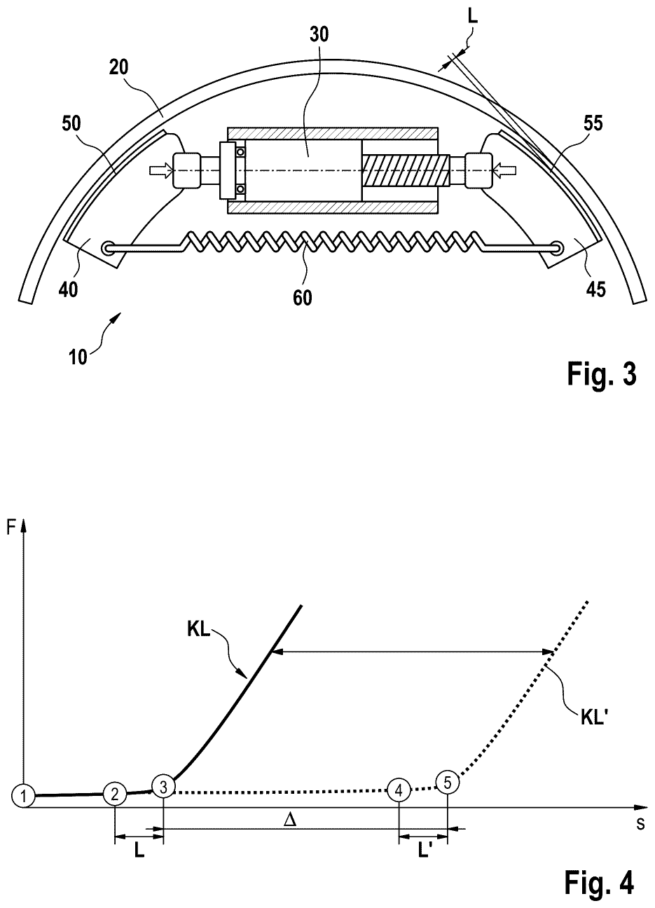

FIG. 3 shows a state of the wheel brake 10 in which the brake pads 50, 55 are more heavily worn than is the case in the states illustrated in FIGS. 1 and 2. This can be determined, for example, by the procedure described hereunder with reference to FIG. 4. However, the air gap L should typically remain constant nevertheless, so that tracking of a resting position is necessary. This can be achieved, for example, in that the energy supplied to the electric actuator 30 for adjusting the air gap L is increased.

FIG. 4 schematically shows part of a force/displacement characteristic line KL when clamping a wheel brake 10 for the purpose of explaining the adjustment, or determination, of a resting position in the context of controlling an electrical wheel brake 10 in an open or closed loop. The solid part of the characteristic line KL herein relates to a quasi wear-free as-new state of consumable brake parts, or by way of example directly following a replacement of all consumable brake parts (essentially a replacement of the brake pads+optionally the brake rotor). A punctiform part of the characteristic line KL′ documents the conditions associated with a progressed state of wear of the brakes. A distance s along a displacement path of an actuator 30 is indicated on the abscissa of the diagram. Owing to the fundamental qualitative discussion of curves, no specific designation of a unit for the actuation travel is required for this purpose. The unit could be only millimeters, for example. A braking force F, which is usually measured in the unit Newton [N] is plotted on the ordinate, said force being able to be measured, for example, by a force sensor FS installed in a wheel brake 10, or alternatively or additionally with a braking momentum-based brake control architecture by a wheel braking momentum sensor TS (torque sensor).

On this basis, the characteristic line KL starts at point 1 in conjunction with a restoring action exerted in an entirely uninhibited manner, such as for example a rear brake stop position, thus in the completely restored state of the actuator mechanism 30, and by way of example in conjunction with restoring means 60 which are effective by being elastically pre-loaded in an unimpeded manner. With the holding current applied, this actuator mechanism achieves the resting position 2 in the air gap range L. The actuator 30 is subsequently activated for braking, and the brake pads 50, 55 come to frictionally engage with the assigned brake rotor 20 (brake disk or, as illustrated, brake drum) at point 3. This becomes apparent at point 3 in that the measured force F increases very significantly in a quasi-linear manner along a characteristic line KL. Accordingly, the defined resting orientation/resting position is assigned to the characteristic line range L ahead of the characteristic line point 3, with the consequence that the thus defined air gap range L is to be maintained reproducibly in a sought and represented manner and in the non-activated driving state of the vehicle for a subsequent service braking action, this resting position being denoted as point 2. Accordingly, the electrical wheel brake 10 in the released brake state is well conditioned for a subsequent service braking action, because the electric actuation device by means of the electric actuator mechanism 30 does not have to bridge any unnecessarily extended empty travels, looseness, clearances, etc., until a brake application point/kiss point is reached at 3.

The discussion of curves pertaining to KL′ prompts the following remarks. As wear on the consumable brake parts progresses, the characteristic line KL is displaced to the right toward KL′ by the additional actuation travel Δ of the actuation device (actuator 30), which is highlighted by the punctiform characteristic line branch KL′. In this case too, the data (actuator current I+actuating force/braking momentum) pertaining thereto obtained by sensors is available to the control unit ECU, but the allocation of the air gap range L′, or the defined resting position 4, respectively, is allocated so as to be offset toward the right by the distance Δ, i.e. during operation the characteristic line KL′ is correspondingly verified, measured or travelled so as to be offset by Δ due to wear, wherein point 5 at which the new kiss point, which due to wear is displaced by the additional distance Δ, manifests itself by means of a substantial increase in force by way of its frictional contact is present so as to be “offset by Δ”, i.e. is obviously displaced toward the right by the distance Δ. In qualitative terms, like before, the defined significant air gap range L′ defines itself up to point 5 for the actuator positioning which is to be adopted and to be maintained in the released state of the brakes. In other words, the new resting position is consequently defined by point 4 and is adopted or maintained, respectively.

Based on the preceding process being carried out repeatedly and optionally periodically, it is made possible for the first time in a sufficiently precise and also economical manner to update a resting position for sizing an air gap so as to be successively verifiable, or to adapt it to progressive wear on the brakes, i.e. to compensate the latter in a customized and individual manner. For a largely uninterrupted successive readjustment for wear it is expedient for a resting position of an electrical wheel brake 10, which has for example been automatically newly acquired by means of the ECU, or which has in any case been identified, to be re-acquired either periodically or at the beginning of each new ignition run, so as to operate the actuator on this basis. Consequently, any actual wear on the brakes is taken into account in a manageably simpler yet nevertheless precise manner. As a result, the air gap position can be used as the defined resting position for the actuation device/actuator mechanism 30 in an electronic control by means of the relevant ESC-ECU in the driving mode of the vehicle. In the process, the resting position 2, 4 is adjusted and maintained by means of electric energy applied in a defined manner, if the released electrical wheel brake 10 is not to generate any braking force in the normal driving mode of the vehicle.

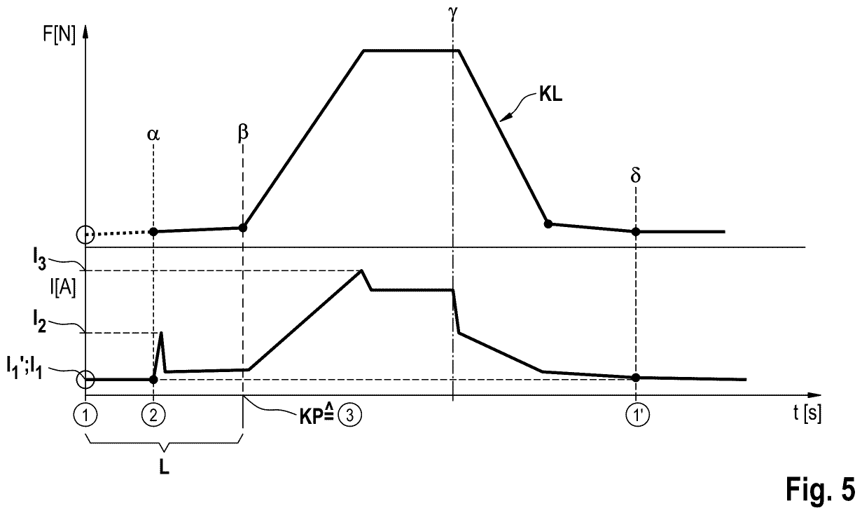

In addition to FIG. 4, FIG. 5 in an upper part of the figure schematically highlights an exemplary characteristic line KL, and with a temporally synchronously associated actuator current profile I in the lower part of the figure. The two profiles herein each proceed from an actively maintained resting point 1 under a holding current I1, so that the actuator 30, which is energized to a relatively minor degree and actively energized for the resting position, by way of the air gap range L thereof counteracts an applied restoring spring force. A brake activation begins at α—corresponding to point 2, wherein an increase in the current with a current peak I 2 symbolizes the startup of a brake actuator powertrain. As from time point β corresponding to kiss point KP=3—the brake clamping force is applied with a noticeable increase, which can be seen by an accompanying quasi-linear current ramp up to a maximum peak at I 3. This is adjoined by a gradual minor current abatement phase and a constant current phase without any noticeable loss in clamping force, this representing the stationary service braking action. A brake releasing action follows at time point γ, in that a termination of a service brake demand is performed physically using different current gradients (to be identified by three gradient profiles of the current curve that decrease, drop differently), until the new brake release position with a new brake resting position is reached at time point 1′=δ. The holding current is reduced to I1′ with and after δ, so that the actuator 30 adopts the new active resting position on this basis and stops so as to assume a new air gap adjustment until further notice.

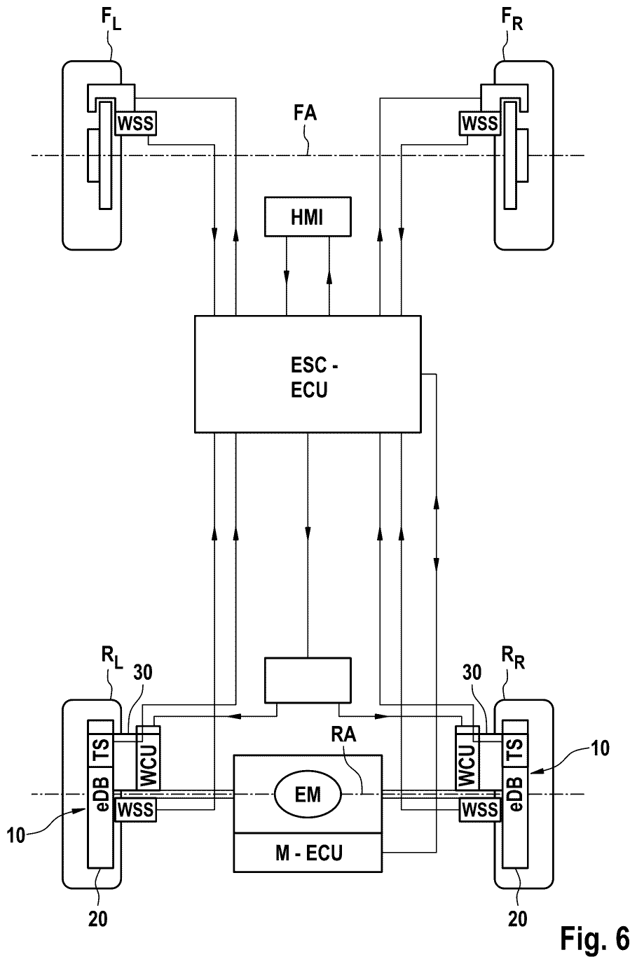

FIG. 6 highlights a vehicle brake system which is designed to be electrically networked and is largely self-explanatory by means of the reference signs therein, having electrical wheel brakes and a brake sensor system TS, which are suitable and specified to carry out the embodiments, also comprising an electric vehicle drive EM which is adapted to be recuperative, including an associated electrical control unit M-ECU which communicates inter alia with the electrical control unit of the brake system ESC-ECU. For reasons of functional reliability, each electrical wheel brake 10 herein is assigned a dedicated local wheel brake control unit WCU, so that emergency braking measures can be performed in an emergency when other components fail, without risking the safety of occupants.

Steps of the method that have been mentioned may be carried out in the order stated. They may however also be carried out in a different order if this is technically appropriate. In one of its embodiments, for example with a specific combination of steps, the method may be carried out in such a way that no further steps are carried out. In principle, however, further steps, even steps which have not been mentioned, may also be carried out.

It is pointed out that features may be described in combination in the claims and in the description, for example in order to facilitate understanding, even though these can also be used separately from one another. A person skilled in the art will recognize that such features may also, independently of one another, be combined with other features or combinations of features.

Dependency references in dependent claims do not exclude other combinations of features.

1. A method for electronic air gap control of an electrical wheel brake of a plurality of wheel brakes for a motor vehicle comprising:
adjusting with an electric actuator an air gap range between at least one adjustable brake shoe and a brake rotor to electrically adopt a defined resting position; and
supplying electric energy to the electric actuator in a defined manner so that the actuator maintains the adopted resting position.

2. The method as claimed in claim 1, further comprising adjusting and maintain the air gap for each wheel brake of the plurality of wheel brakes in a wheel-specific manner by a control unit.

3. The method as claimed in claim 1, wherein the wheel brake is a drum brake.

4. The method as claimed in claim 1, wherein the wheel brake is a disk brake.

5. The method as claimed in claim 1, further comprising updating the resting position continuously during operation of the wheel brake.

6. The method as claimed in claim 1, further comprising automatically verifying and/or undating the resting position with the control unit each time the brake is activated.

7. The method as claimed in claim 1, wherein the wheel brake has at least one restoring element which pre-load the brake shoes to a non-activated position.

8. The method as claimed in claim 1, wherein the wheel brake does not have any mechanical air gap adjustment means.

9. The method as claimed in claim 1, further comprising supplying the electric energy with an output of approximately 1 W at most.

10. The method as claimed in claim 1, further comprising controlling the electric energy supplied to maintain the resting position.

11. The method as claimed in claim 1, further comprising actively retracting the brake shoes with the actuator.

12. The method as claimed in claim 1, further comprising tracking the resting position as a function of at least one parameter.

13. The method as claimed in claim 10, further comprising tracking the resting position based on measured force/displacement characteristic lines.

14. The method as claimed in claim 1, further comprising newly determining the resting position at the beginning of each ignition run.

15. The method as claimed in claim 1, wherein an air gap mode selection is provided.

16. The method as claimed in claim 1, wherein a fail-safe mode is programmed for an identified fault, which has priority over any air gap mode selection.

17. An electronic motor vehicle brake system for a plurality of electrical wheel brakes comprising:
a brake rotor;
a brake stator;
at least one adjustable brake shoe which is activatable in the direction of the brake rotor by the electric actuator and is mounted so as to be restorable; and
an electronic control unit with instructions for:
adjusting with the electric actuator an air gap range between the at least one adjustable brake shoe and the brake rotor to electrically adopt a defined resting position; and
supplying electric energy to the electric actuator in a defined manner so that the actuator maintains the adopted resting position.

18. The electronic motor vehicle brake system as claimed in claim 17, wherein at least one of a vehicle powertrain and a recuperative motor vehicle brake system has at least one more electronic control unit and at least one of a motor vehicle drive and an actuated powertrain brake, and wherein the electronic control units of the systems=cooperate with one another for the purpose of exchanging data.
